(19) United States
(12) Patent Application Publication
(10) Pub. No.: US 2015/0127388 A1
(43) Pub. Date: May 7, 2015

(54) NOTIFICATION AND MANAGEMENT OF ABNORMAL VEHICULAR MOVEMENT EVENTS

(71) Applicant: Himex Limited, London (GB)

(72) Inventor: Russ L. OLDHAM, Scottsdale, AZ (US)

(21) Appl. No.: 14/532,084

(22) Filed: Nov. 4, 2014

Related U.S. Application Data
(60) Provisional application No. 61/899,483, filed on Nov. 4, 2013.

(51) Int. Cl. G06Q 40/08; G07C 5/00

(52) U.S. Cl. CPC G06Q 40/08; G07C 5/008
USPC 705/4

(57) ABSTRACT

A system is described for notification of abnormal vehicular movement events. The system comprises a gateway device for communicating with vehicle monitoring devices for receiving data associated with abnormal vehicular movement events. A processing system is operatively associated with the gateway device for processing the received data. The processing system implements an event routine using the received data to automatically categorize an abnormal vehicular movement event based on severity and type of the event. A validation routine analyzes the received data to verify that an abnormal vehicular movement event has occurred. A notification routine automatically initiates a notice of loss claim and triggers communication with a client that a validated abnormal vehicular movement event has occurred and including data related to the severity and type of the event.

### CROSS-REFERENCE TO RELATED APPLICATIONS

This application claims priority of provisional application No. 61/899,483, filed Nov. 4, 2013.

### FEDERALLY SPONSORED RESEARCH OR DEVELOPMENT

Not Applicable.

### MICROFICHE/COPYRIGHT REFERENCE

Not Applicable.

### FIELD OF THE INVENTION

This application relates to insurance claim processing and, more particularly, to notification and management of abnormal vehicular movement events.

### BACKGROUND

Late reporting of losses has plagued personal and commercial line automobile insurance carriers for years. Delayed loss reporting often leads to increased cost both for physical damage and bodily injury. There also may be prolonged liability investigations due to a cold evidence trail and heightened consumer dissatisfaction.

Many insurance carriers have attempted to compress life cycle by encouraging prompt reporting of losses. One known solution offered policy holders a reduced physical damage deductible for prompt reported losses. Another known carrier scaled producer compensation based on the loss reporting behavior of their insureds. However, neither resulted in a significant change in loss reporting timeliness. Thus, the insurers' attempts to compress the claim life cycle had failed to produce the desired results due to the reliance upon policy holders and claimants to timely report losses.

The present application is directed to improvements in notification and management of abnormal vehicular movement events to thereby improve loss reporting and claims adjustment processes.

### SUMMARY

As described herein, an improved claim system allows a connected vehicle to electronically transmit notice of loss to a first party insurance provider within seconds of an abnormal vehicular movement event. The system automates the first notice of loss process, categorizes type and severity of the event and selectively notifies safety providers and vendors, assigns designated representatives to the loss, verifies key coverage elements and offers a dynamic reconstruction of occurrence events in visual form.

There is disclosed in accordance with one aspect a system for notification of abnormal vehicular movement events. The system comprises a gateway device for communicating with vehicle monitoring devices for receiving data associated with abnormal vehicular movement events. A processing system is operatively associated with the gateway device for processing the received data. The processing system implements an event routine using the received data to automatically categorize an abnormal vehicular movement event based on severity and type of the event. A validation routine analyzes the received data to verify that an abnormal vehicular movement event has occurred. A notification routine automatically initiates a notice of loss claim and triggers communication with a client that a validated abnormal vehicular movement event has occurred and including data related to the severity and type of the event.

In one aspect, the abnormal vehicular movement event may comprise a G-force measurement being above a select threshold. The received data comprises vehicle movement data for a select time period after the abnormal vehicular movement event. The validation routine analyzes the vehicle movement data subsequent to the abnormal vehicular movement event and verifies that an abnormal vehicular movement has occurred if the vehicle stops moving during the select time period.

In another aspect, the abnormal vehicular movement event may comprise an acoustic measurement being above a select threshold. The received data comprises vehicle movement data for a select time period after the abnormal vehicular movement event. The validation routine analyzes the vehicle movement data subsequent to the abnormal vehicular movement event and verifies that an abnormal vehicular movement has occurred if the vehicle stops moving during the select time period.

In still another aspect, the abnormal vehicular movement event may comprise a G-force measurement and an acoustic measurement both being above a select threshold. The received data comprises vehicle movement data for a select time period after the abnormal vehicular movement event. The validation routine analyzes the vehicle movement data subsequent to the abnormal vehicular movement event and verifies that an abnormal vehicular movement has occurred if the vehicle stops moving during the select time period.

It is a feature that the abnormal vehicular movement event comprises one of a G-force measurement or acoustic measurement being above a select threshold, or an air bag deployment or a crash sensor activation.

In accordance with another feature, the event routine may receive a validation score from the validation routine and generate an output comprising vehicle identification information and transfer the output to the notification routine.

It is another feature that the notification routine may comprise a source rules routine which automatically searches for information on road, weather and traffic conditions at a time and location of the abnormal vehicular movement event.

The notification routine may also comprise a source rules routine which automatically searches for first responders and health care facility's proximate location of the abnormal vehicular movement event.

The notification routine may further comprise a business rules routine which selectively automatically generates a notification message to a carrier and authorities.

It is a further feature that the notification routine may automatically verify coverage based on time and location of the abnormal vehicular movement event and the vehicle identification information.

It is yet another feature that the notification routine may automatically generate a dynamic visual reconstruction of the abnormal vehicular movement event.

There is also disclosed a method for notification and management of abnormal vehicular movement events, comprising: communicating with vehicle monitoring devices for receiving data associated with abnormal vehicular movement events; and operating a processing system to automatically process the received data, comprising implementing, an event routine using the received data to automatically categorize an abnormal vehicular movement event based on severity and type of the event, a validation routine to analyze the received data to verify that an abnormal vehicular movement event has occurred, and a notification routine to automatically initiate a notice of loss claim and trigger communication with a client that a validated abnormal vehicular movement event has occurred and including data relating to the severity and type of the event.

Further features and advantages will be readily apparent from the specification and from the drawings.

### BRIEF DESCRIPTION OF THE DRAWINGS

FIG. 1 is a diagrammatic representation of features of an electronic first notice of loss process provided with the system and methods described herein;

FIG. 2 is a block diagram of the system for notification of abnormal vehicular movement events described herein;

FIG. 3 is an expanded view of the ICE system shown in FIG. 3;

FIG. 4 is a generalized diagram illustrating data transferred from vehicle monitoring devices associated with abnormal vehicular movement events;

FIG. 5 is a flow diagram illustrating operation of the ICE system of FIG. 2;

FIG. 6 is a detailed flow diagram illustrating an event routine and a validation routine;

FIG. 7 is a flow diagram illustrating a notification routine;

FIG. 8 is a block diagram illustrating communications with vehicle monitoring devices;

FIG. 9 is a flow diagram illustrating integration options for the ICE system; and

FIG. 10 illustrates dynamic visual reconstruction of the abnormal vehicular movement event as provided by the ICE system described herein.

### DETAILED DESCRIPTION

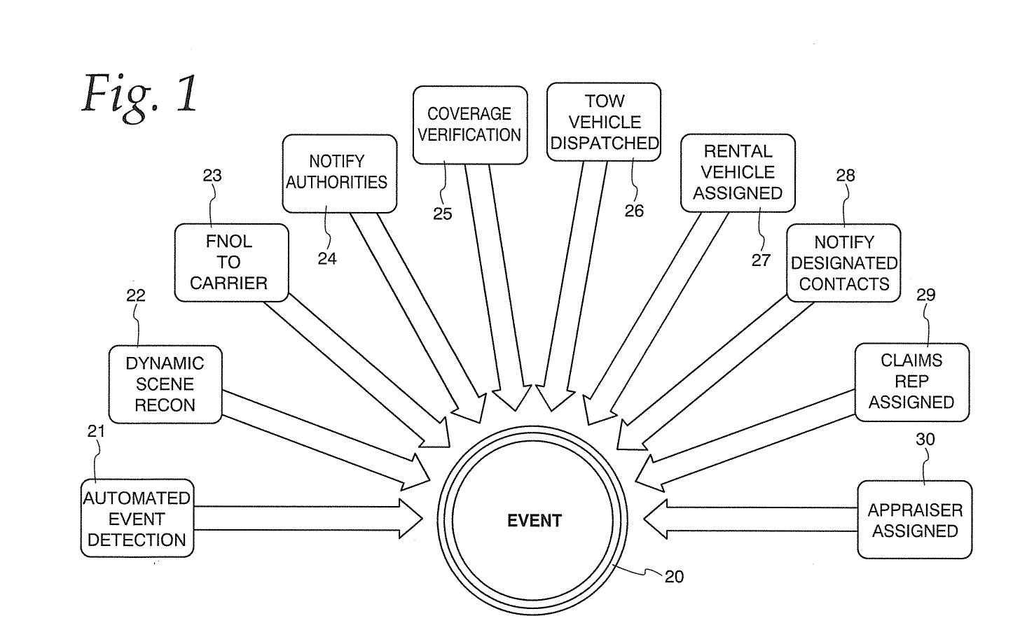

The system and methodology described herein comprises an intelligent claims environment (ICE) that automates the traditional first notice of loss (FNOL) process through electronically notifying insurance carriers, fleet managers, or any other client of an event within seconds after an event. FIG. 1 illustrates notifications and other features of the ICE subsequent to an event represented by a node 20. The event comprises an abnormal vehicular movement occurrence, as described more particularly below.

An automated event detection block 21 initiates the FNOL. Events are pre-determined behavioural triggers that are detected through a monitoring device associated with a vehicle. The monitoring device may be a conventional onboard diagnostic (OBD) device, a hard wired black box, embedded OEM telematics devices, or the like. The monitoring device may also be a mobile device present in a vehicle. The monitoring device(s) measure driving and vehicle movement characteristics which may indicate that a loss has occurred. Loss detection measurements and thresholds may include, for example, sudden acceleration, sudden deceleration, abnormal G-force readings, abnormal acoustic readings, crash sensor activation, roll over sensor activation, electronic control unit readings, air bag deployment, or the like.

Dynamic scene reconstruction is illustrated by a block 22. The ICE system stores driving and vehicle movement data up to a pre-set number of seconds before and after an event. This allows the ICE system to produce an animated recreation of the vehicle's movement and behaviour in a setting that mirrors that of the event. Each simulated video will track the location of the vehicle up to the point of impact and pinpoint its location based on latitude and longitude.

An FNOL to carrier block 23 allows a client to be notified of an event within seconds of occurrence through an ICE automated notification process. Notification can be via internet, text message, email message, social media, telephone call or any other communication method. Authorities are notified at a block 24. The ICE system may integrate with third party database providers of police, sheriff, fire departments, EMT/Ambulance companies, etc. An event triggers an automated email, electronic text or telephone message to the proper jurisdictional authority or client or other third party with notification of the event location, vehicle description and policy holder's name.

With a coverage verification block 25, the ICE system may integrate with a client's policy administration system to verify high level coverage requirements, such as policy period, location of event and vehicle. A tow vehicle dispatched block 26 works with a database that houses detailed profiles of previously sanctioned vehicle recovery vendors. The profile information includes geographic coverage area, location, hours of operation, vehicle recovery capacity, including gross vehicle weight (GVW), and pricing. A reverse auction process may weigh these factors to determine a lowest cost option along with most timely response. Once the ICE system's algorithm selects the vendor, an electronic message is sent to both the vehicle owner and the vendor with key dispatch information, including location and vehicle information. The vehicle owner's message will include name and telephone number of the vehicle recovery vendor that has been dispatched. Dispatch occurs within seconds of the event notification.

A rental vehicle assigned block 27 is used with a database and houses detailed profiles of automobile rental vendors who have been previously sanctioned by the client. This operates similar to the tow vehicle dispatched block 26, discussed above.

The ICE system can integrate with a carrier's policy administration system to locate the name, email address and telephone numbers of a vehicle owner's designated contacts. This is used at a notify designated contacts block 28. Once an event is triggered, the ICE system immediately generates an email, text or automated voice message notifying the designee that an event has occurred. Clients can also feed contact information to an ICE database, thus eliminating the need for full integration. The ICE system can be integrated with a client's claims administration system to assign a claim rep at a block 29. Finally, the ICE system can integrate with a client's claim or policy administration system to assign an appraiser at a block 30.

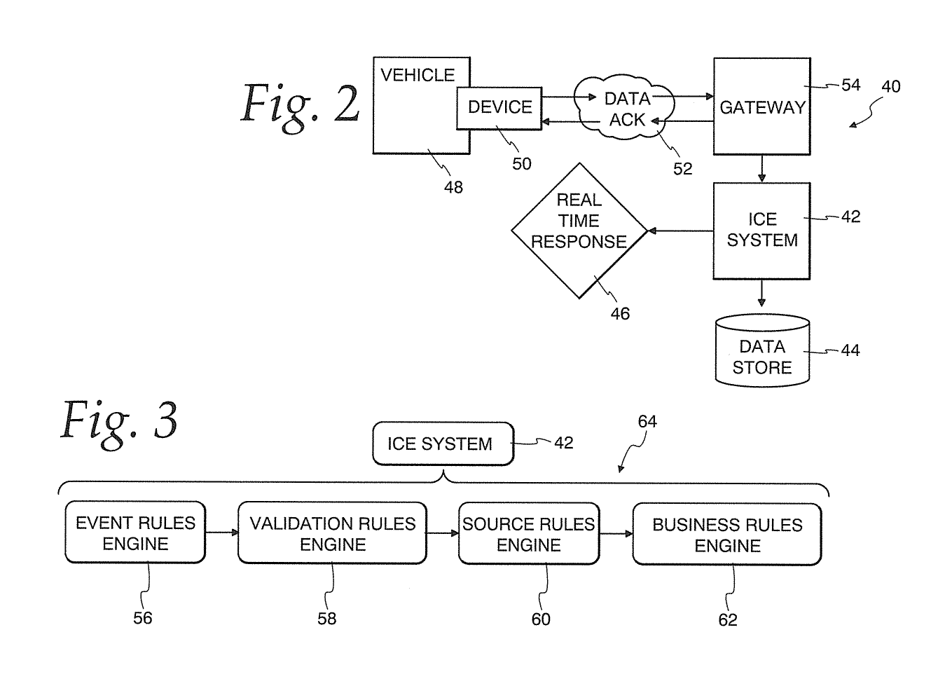

FIG. 2 comprises a block diagram showing an exemplary notification and management system 40. An ICE system 42 comprises a programmed computing system that combines hardware and software and related user interfaces for implementing the intelligent claims environment described herein. The ICE system 42 may include one or more processors, personal computers, servers or the like, as necessary or desired. The ICE system 42 utilizes a data store device 44 which may comprise a database and other types of memory devices for storing data and programs used by the ICE system 42. The ICE system 42 may communicate with a carrier's real time response system 46 which may comprise a carrier's computer system and other devices to implement the features discussed above relative to FIG. 1.

The ICE system 42 is used to communicate with a plurality of insured vehicles, one of which is illustrated at 48. Each vehicle 48 includes a monitoring device 50. The monitoring device 50 may comprise a dongle device, onboard diagnostic (OBD) device, global positioning system (GPS) device, mobile device, such as a smart phone or tablet, or other telematic device, as discussed above. Also, there may be more than one monitoring device used. The monitoring device 50 communicates wirelessly via a network 52 to a gateway 54. The gateway 54 comprises a communications server operatively connected to the ICE system 42. The gateway 54 accepts data messages from the device 50, decodes the message and routes it to the ICE system 42. The gateway 54 also provides an acknowledgment to the device 50. The ICE system 42 is operable to use received data associated with abnormal vehicular movement events from the gateway 54 and to determine if a collision has occurred and then take appropriate action as described below.

The ICE system 42 includes numerous main rules engines, see FIG. 3, which drive the system. These are also referred to herein as routines. An event rules engine 56 receives data from a monitoring device 50 which has been transmitted via a cellular network, or other communication network, to the gateway 54. The event rules engine 56 reads vehicle data used to determine if an abnormal vehicle movement event has occurred. If so, the event rules engine 56 collects and determines one or more of G-force severity, speed, acceleration, deceleration, acoustic readings, vehicle readings, control sensors, ECU, air bag deployment, roll over sensors, etc. The event rules engine also provides key vehicle data, such as head light and tail light operation, turn signals, seat belt usage, seat belt sensor readings, etc. The event rules engine 56 also provides severity levels and impact types.

A validation rules engine 58 receives input from the event rules engine 56 to determine the likelihood that an actual event has occurred. Among other measurements, the validation rules engine 58 checks to see if the vehicle has traveled further on a normal pace after the occurrence, which would indicate that an event did not occur.

A source rules engine 60 searches for demographic, geospatial, social media, government and other information sources. This is done to help determine the road, weather and traffic conditions at the time of loss. The source rules engine 60 also finds nearby vendors, first responders, medical care, etc. and houses client and contact information. A business rules engine 62 obtains information from the source rules engine. Client information and rules are housed in this engine. Clients can configure the event handling flow along with which features they wish to engage or not, severity levels, etc. The source rules engine 60 and business rules engine 62 are also collectively referred to herein as a notification routine 64.

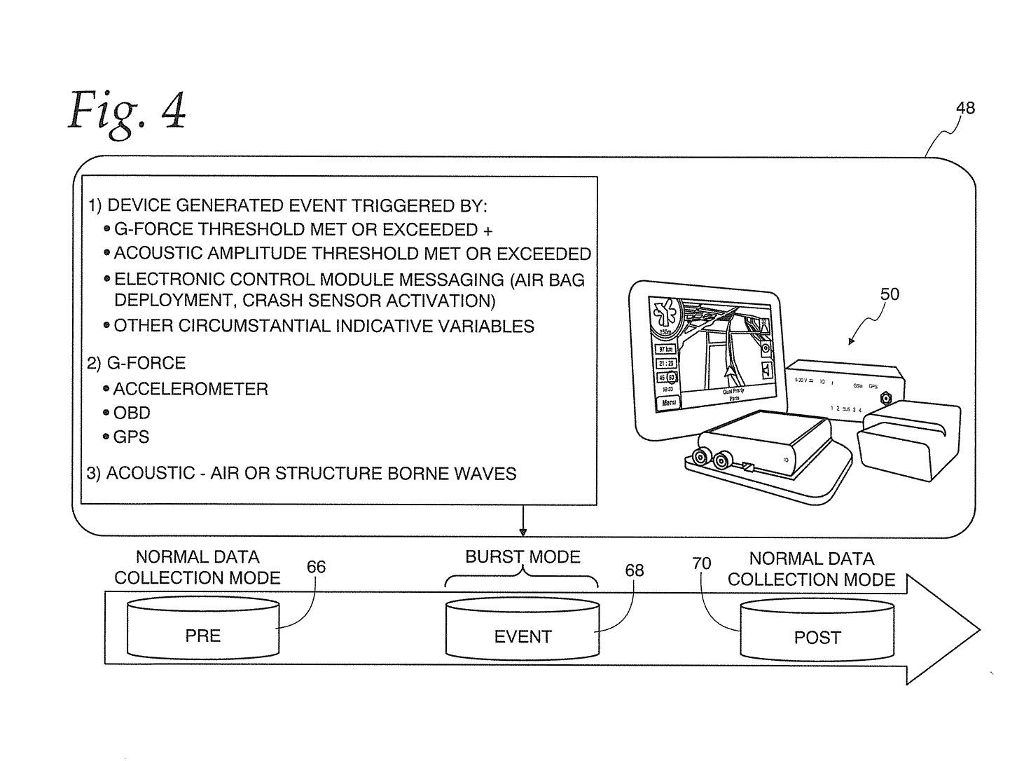

Referring to FIG. 4, various representative monitoring devices 50 are illustrated in a vehicle, represented by 48. These monitoring devices 50 are configured to generate an event trigger by one or more of several occurrences. These include, for example, a G-force threshold being met or exceeded, an acoustic amplitude threshold being met or exceeded, an electronic control module message, such as air bag deployment or crash sensor activation, or other circumstantial indicative variables. The G-force data may be determined from an accelerometer, an OBD device or GPS device. As will be appreciated, a device generated event can also be triggered by combinations of the various measured variables, such as both a G-force measurement and an acoustic measurement both being above a select threshold. The data measured by the monitoring device 50 is stored in a buffer which holds data for a select period of time, such as on the order of forty seconds. In a normal data collection mode, the buffer is continually updated with the oldest data being purged and replaced by newer data. If an event is triggered, then the monitoring device continues to collect data subsequent to the event as well as storing the buffer data from before the event. In an illustrated embodiment, the data may include data for approximately twenty seconds before the event in a pre-buffer 66, data at the time of the event at an event buffer 68 and data for approximately twenty seconds after the event at a post-buffer 70. A burst mode is initiated to transmit the buffered data via the network 52, see FIG. 2, to the gateway 54. As will be apparent, the above times are by way of example only and can be adjusted as necessary or desired.

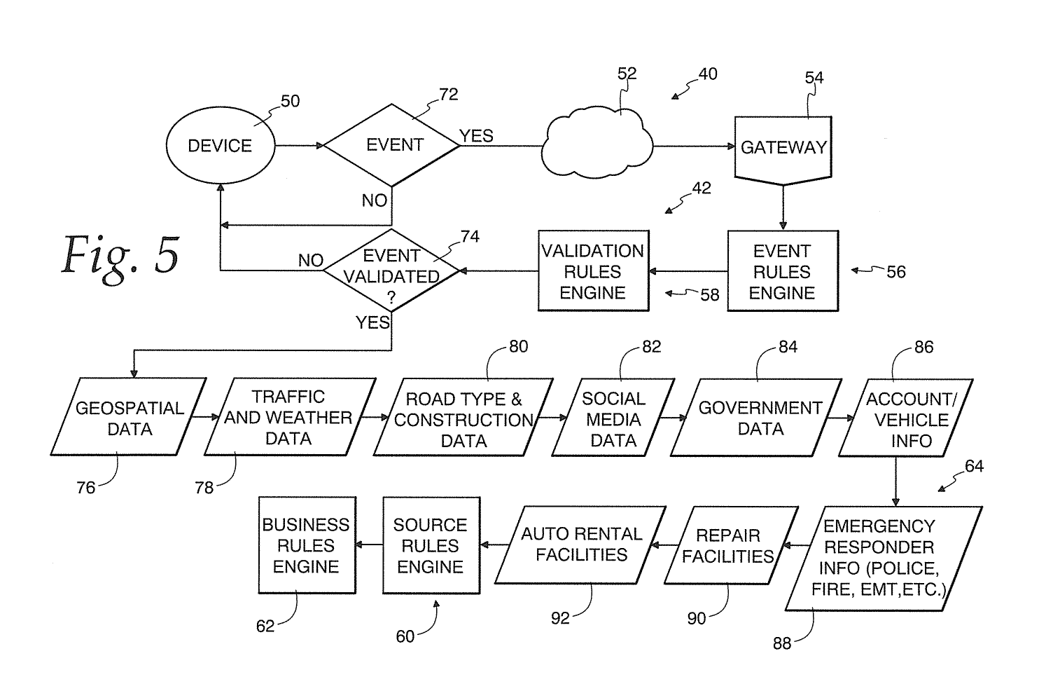

FIG. 5 comprises a high level overview flow chart functionally illustrating operation of the system 40. The monitoring device 50 continually generates data associated with vehicle operation. A decision block 72, associated with the monitoring device 50, determines if an event has been triggered, as discussed above relative to FIG. 4. If not, then the process flow returns to monitoring by the monitoring device 50. If an event has been triggered, then the monitoring device 50 transmits data associated with the abnormal vehicular movement event via the network 52 to the gateway 54. The data transmitted includes precise time, date and location of the event, driving behavior and vehicle status before, during and after the event, G-force impact analysis, cause of the trigger, and the number of occupants in the vehicle at the time of impact. All of these data elements can be used along with locational weather conditions, posted speed and actual speed at time of event and compared to information submitted by the policy holder, driver, third party claimant or other claim participant.

The gateway 54 provides the received data to the ICE system 42, particularly the event rules engine 56 which provides necessary information to the validation rules engine 58. A decision block 74, associated with the validation rules engine 58, determines if the event is validated, as discussed below. If not, then the process flow ends and returns to monitoring by the monitoring device 50. If an event is validated, then the system obtains other relevant data, such as, for example, geospatial data at a block 76, traffic and weather data at a block 78, road type and construction data at a block 80, social media data at a block 82, government data at a block 84, account/vehicle information at a block 86, emergency responder information at a block 88, repair facility information at a block 90 and auto rental facility information at a block 92. This information is provided to the source rules engine 60 and to the business rules engine 62 for making the appropriate notifications and automatically initiates notice of loss claim and trigger communication with a client that a validated abnormal vehicular movement has occurred and including data relating to the severity and type of the event and other data associated with the event.

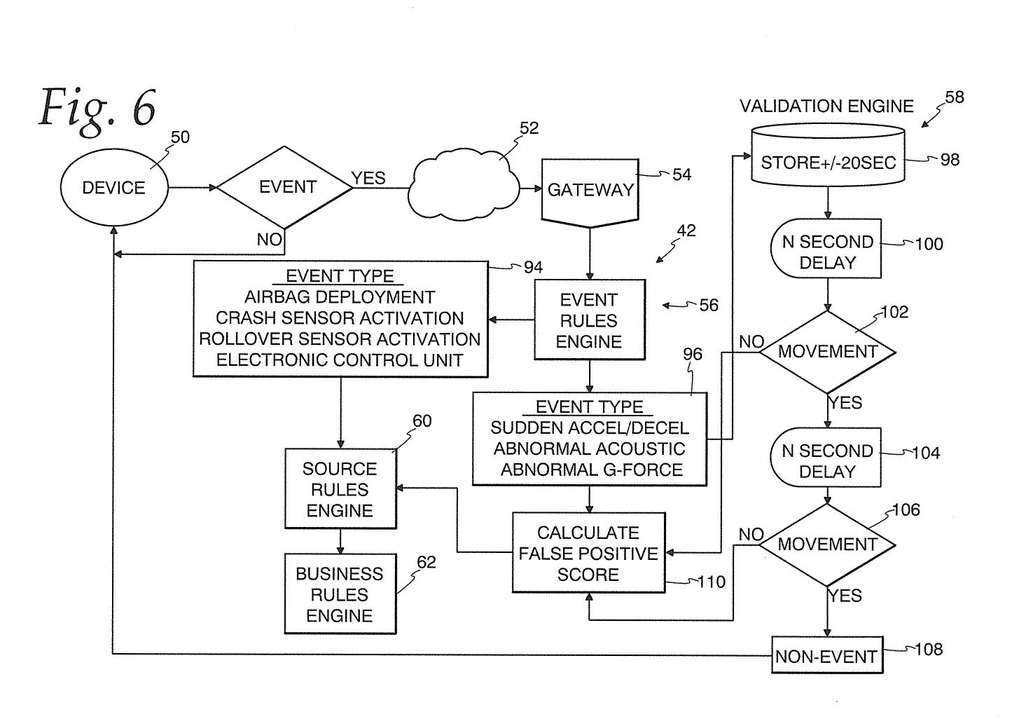

Referring to FIG. 6, the event rules engine 56 and validation engine 58 are illustrated in greater detail. The event rules engine 56 initially categorizes an abnormal vehicular movement event based on severity and type of the event. If the event type is an air bag deployment, crash sensor activation, rollover sensor activation or an electronic control unit, each representing a defined event, then the event rules engine proceeds to a block 94. The event rules engine then passes the received data to the source rules engine 60 and business rules engine 62. Otherwise, if the event is categorized as sudden acceleration, sudden deceleration, abnormal acoustic signal or abnormal G-force, then the system advances to a block 96 which interfaces with the validation engine 58. The validation engine 58 begins at a node 98 which extracts the data for the time of the event and for the period subsequent to the event which may be on the order of twenty seconds. From the time of the occurrence of the event, the validation engine uses an N second delay, which may be on the order of ten seconds. Thereafter, a decision block 100 determines if there is normal vehicular movement. If so, then another N second delay is implemented at a block 104 and then a decision block 106 determines if there is normal vehicular movement. If so, then the validation engine assumes that the event consisted of the vehicle hitting a pothole or speed bump or the like as the vehicle has resumed normal movement. The occurrence is then classified as a non-event at a block 108 and the routine ends and returns to monitoring by the monitoring device 50.

If no further vehicle movement is detected at the blocks 102 or 106, then a block 110 calculates a false positive score and this can represent the severity level of the event. This score is provided to the event rules engine 56.

The event rules engine 56 develops an output to the source rules engine 60 which includes the calculated validation score, post event vehicle status, raw accelerometer data, such as G-force severity, duration and rollover, OBD or GPS speed, if the accelerometer speed is not available. Vehicle identification information, such as VIN number, year, make and model, trip data and acoustic may also be transferred.

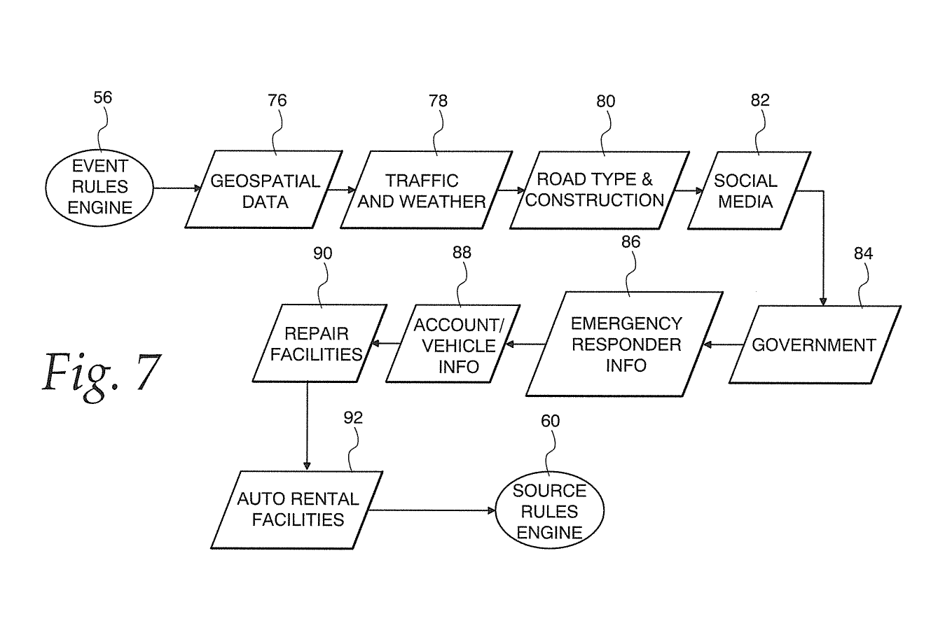

The source rules engine 60 then searches other information sources, represented by the block 76-92, see FIG. 7, to look for a demographic, geospatial, social media, government and other information sources, as discussed above relative to FIG. 1. This information is used to determine road, weather and traffic conditions at the time of loss, to find nearby vendors, first responders, medical care facilities and the like, and obtain client and contact information.

The business rules engine 62 then uses any available client information and rules to make the appropriate notifications and take other actions. As part of this, the ICE system 42 may assign an event number and/or a claim number and populate the necessary FNOL fields such as date of loss, time of loss, vehicle information, location of loss and vehicle damage, if known. This can be determined through onboard diagnostics to crash sensor activation along with accelerometer and/or acoustic readings. The ICE system 42 may notify the appropriate authorities such as the police and/or fire department by appropriate communication, as noted above. The ICE system 42 offers clients the opportunity to customize severity settings. For example, with low impact events, a client may elect to not notify the authorities. Severity is determined by an appropriate algorithm that includes one or more of G-force, acoustic measurements, deceleration, acceleration, crash sensor and air bag deployment readings, as desired by the client.

The ICE system 42 can be used to selectively notify designated contacts. Contact information will be collected from the insured/applicant at the time of policy inception. The ICE system 42 can integrate with a carrier's policy administration system to locate the name, email address and telephone number of the designated contacts. Once an event is triggered and depending on the severity of the event, and the insurer's agreed upon business processes, the ICE system 42 will immediately generate an email, text or automated voice message to notify the designee that an event has occurred. The clients can also feed contact information to the ICE system database 44, thus eliminating the need for full integration.

The ICE system 42 can be integrated with a client's claim administration system to assign a claim representative or a group of claim representatives to any given loss. The ICE system's algorithm analyzes and weighs several variables in determining assignment, including geographic territory, skill set, work load, rotation, regulatory licensing and availability.

The ICE system 42 can be integrated with a client's claim administration system to assign a damage appraiser to any given loss. The ICE system's algorithm analyzes and weighs several variables in determining assignment, including geographic territory, skill set, work load, rotation, regulatory licensing and availability.

The ICE system 42 can be integrated with a carrier's policy administration system to ensure key covered elements are in order prior to implantation of the other features. These coverage elements include policy status, whether the event occurred within the policy term, whether the event vehicle is listed on the policy, and whether the event occurred within a covered geographic area.

The ICE system 42 can be configured to assign an authorized dispatch of vehicle recovery specialists, such as tow trucks and wrecking vendors. The database 44 stores detailed profiles of vehicle recovery vendors who have previously been sanctioned and may include geographic coverage area, location, hours of operation, vehicle recovery capacity, including GVW and pricing. A reverse auction process may be implemented to weigh these factors to determine the lowest cost option along with most timely response. Once a vendor is selected, the electronic message is sent to both the vehicle owner and the vendor with key dispatch information, including location and vehicle information. The vehicle owner's message will provide notification of the name and telephone number of the dispatched vehicle recovery vendor. Thus, dispatch occurs within seconds of the event notification.

The ICE system 42 may assign a temporary replacement vehicle such as a rental auto. This may operate similar to the dispatch of vehicle recovery specialists.

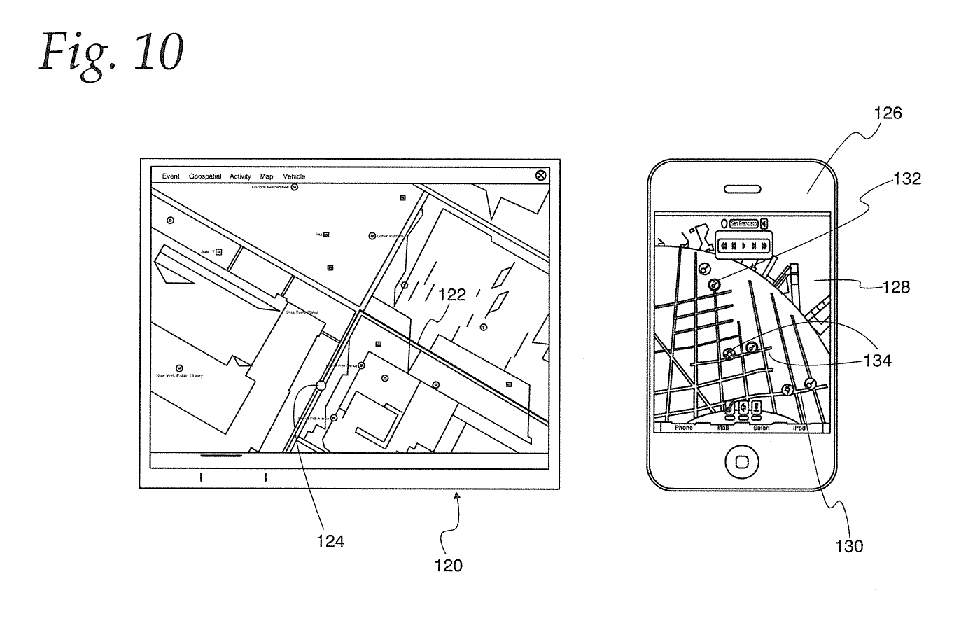

The ICE system 42 receives and stores vehicle data a select time period before and after an event. This allows the ICE system 42 to produce an animated recreation of the vehicle's movement and behavior in a setting that mirrors that of an event. The simulated video will track the location of the vehicle up to the point of impact and pinpoint its location. This is illustrated variously in FIG. 10 which shows a computerized display 120 in the form of a map showing the vehicle route at 122 and the location of impact at 124. Similarly, a smart phone 126 can be used to display a map 128 showing vehicle movement at 130 and location of the event at 132 with intermediate points represented at other positions 134. This can also be implemented using a ground level view or bird's eye view, or the like, including an actual video representation of the vehicle prior to and at the time of the occurrence of the event.

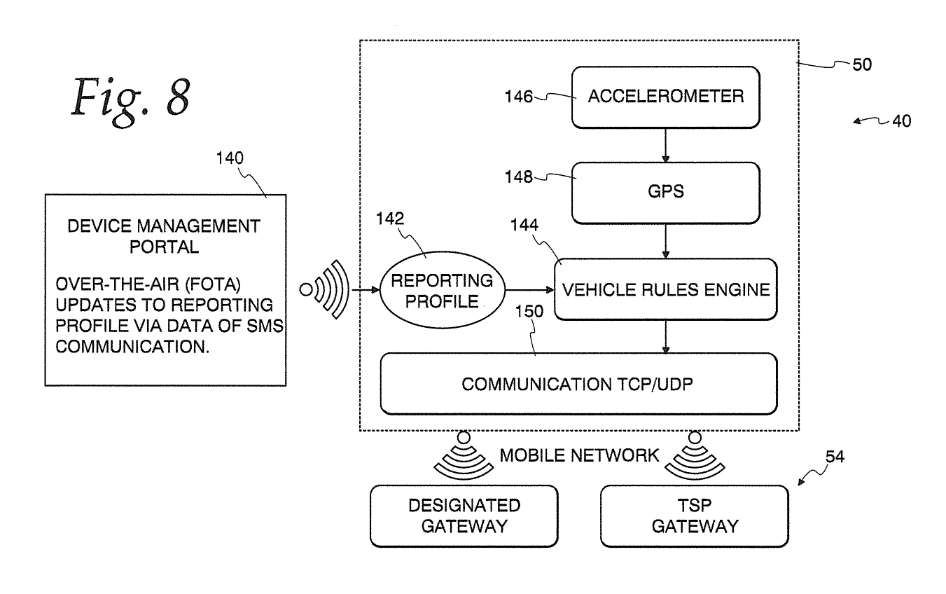

FIG. 8 illustrates communications within the system 40 relative to the monitoring device 50. The primary mode of transmission is the device 50 reporting directly to the gateway 54. However, the system 40 supports data transmission to a third party gateway or to multiple gateways. The device 50 may communicate with a device management portal 140 which provides over the air updates to a reporting profile 142 of the device 50 via data of SMS communications. This can be used to update a vehicle rules engine 144. The vehicle rules engine 144 receives various data such as discussed above, including, without limitation, accelerometer 146 and GPS 148. The vehicle rules engine 144 can then be used to determine if an abnormal vehicular movement event has occurred, as discussed above, and uses a communication protocol 150 for communicating over a mobile network to a gateway device 54, such as a TSP gateway or other designated gateway.

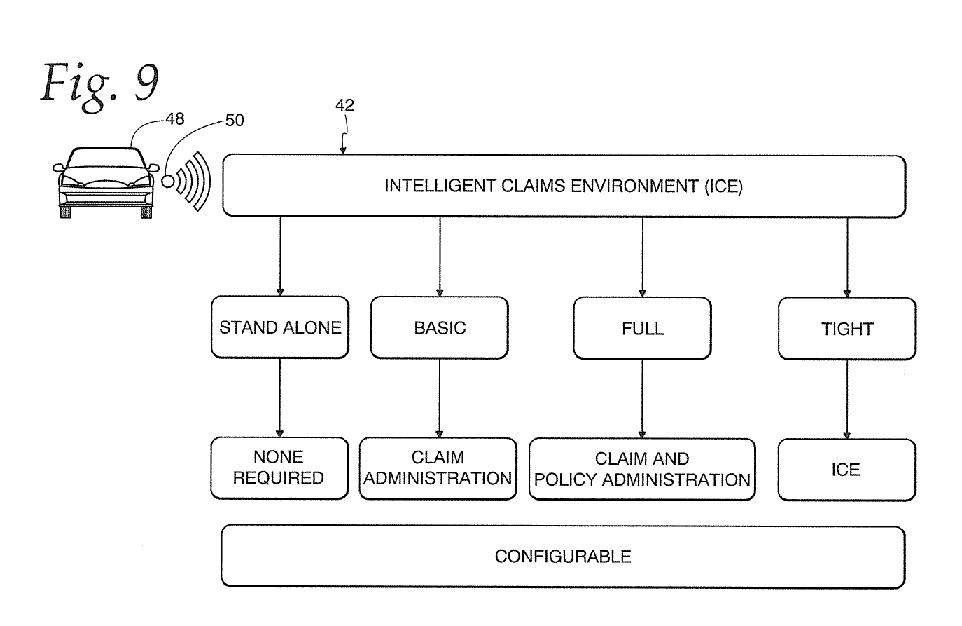

The ICE system 42 can be deployed as a standalone application or along with existing usage based insurance, behavioral based insurance, fleet management or other telematics solution, as illustrated in FIG. 9. The ICE system 42 can be implemented in the stand alone mode with no integration required. The FNOL would be transmitted directly via internet, cellular, etc. In a basic mode, for integrating with a claim administration application, fields are populated including FNOL, assigning claims representatives and appraisers. A full mode integrates with a claim and policy administration application. This allows the system 40 to validate key coverage points, notify designated contacts, and perform most ICE functions. A so-called tight mode is used for SOAP or rest API integration.

Thus, as described herein, a system is provided for notification of abnormal vehicular movement events. The system 42 comprises a gateway device 54 for communicating with vehicle monitoring devices 50 for receiving data associated with abnormal vehicular movement events. The ICE processing system 42 is operatively associated with the gateway device 54 for processing received data. The ICE system 42 implements an event routine 56 for using the received data to automatically categorize abnormal vehicular movement event based on severity and type of event. The validation routine 58 analyzes the received data to verify that an abnormal vehicular movement has occurred. The notification routine 64 automatically initiates a notice of loss of claim and triggers communication with a client that a validated abnormal vehicular movement event has occurred and includes data relating to the severity and type of the event.

It will be appreciated by those skilled in the art that there are many possible modifications to be made to the specific forms of the features and components of the disclosed embodiments while keeping within the spirit of the concepts disclosed herein. Accordingly, no limitations to the specific forms of the embodiments disclosed herein should be read into the claims unless expressly recited in the claims. Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A system for notification of abnormal vehicular movement events, comprising:
a gateway device for communicating with vehicle monitoring devices for receiving data associated with abnormal vehicular movement events;
a processing system operatively associated with the gateway device for processing the received data, the processing system implementing
an event routine using the received data to automatically categorize an abnormal vehicular movement event based on severity and type of the event,
a validation routine to analyze the received data to verify that an abnormal vehicular movement event has occurred, and
a notification routine to automatically initiate a notice of loss claim and trigger communication with a client that a validated abnormal vehicular movement event has occurred and including data relating to the severity and type of the event.

2. The system of claim 1 wherein the abnormal vehicular movement event comprises a G-force measurement being above a select threshold, and the received data comprises vehicle movement data for a select time period after the abnormal vehicular movement event, wherein the validation routine analyzes the vehicle movement data subsequent to the abnormal vehicular movement event and verifies that an abnormal vehicular movement event has occurred if the vehicle stops moving during the select time period.

3. The system of claim 1 wherein the abnormal vehicular movement event comprises an acoustic measurement being above a select threshold, and the received data comprises vehicle movement data for a select time period after the abnormal vehicular movement event, wherein the validation routine analyzes the vehicle movement data subsequent to the abnormal vehicular movement event and verifies that an abnormal vehicular movement event has occurred if the vehicle stops moving during the select time period.

4. The system of claim 1 wherein the abnormal vehicular movement event comprises a G-force measurement and an acoustic measurement both being above a select threshold, and the received data comprises vehicle movement data for a select time period after the abnormal vehicular movement event, wherein the validation routine analyzes the vehicle movement data subsequent to the abnormal vehicular movement event and verifies that an abnormal vehicular movement event has occurred if the vehicle stops moving during the select time period.

5. The system of claim 1 wherein the abnormal vehicular movement event comprises one of a G-force measurement or an acoustic measurement being above a select threshold, or an air bag deployment or a crash sensor activation.

6. The system of claim 1 wherein the event routine receives a validation score from the validation routine and generates an output comprising vehicle identification information, vehicle location information and the validation routine and transfers the output to the notification routine.

7. The system of claim 6 wherein the notification routine comprises a source rules routine which automatically searches for information on road, weather and traffic conditions at a time and location of the abnormal vehicular movement event.

8. The system of claim 6 wherein the notification routine comprises a source rules routine which automatically searches for first responders and healthcare facilities proximate location of the abnormal vehicular movement event.

9. The system of claim 6 wherein the notification routine comprises a business rules routine which selectively automatically generates a notification message to a carrier and authorities.

10. The system of claim 6 wherein the notification routine automatically verifies coverage based on time and location of the abnormal vehicular movement event and the vehicle identification information.

11. The system of claim 6 wherein the notification routine automatically generates a dynamic visual reconstruction of the abnormal vehicular movement event.

12. A method for notification and management of abnormal vehicular movement events, comprising:
communicating with vehicle monitoring devices for receiving data associated with abnormal vehicular movement events;
operating a processing system to automatically process the received data, comprising implementing,
an event routine using the received data to automatically categorize an abnormal vehicular movement event based on severity and type of the event,
a validation routine to analyze the received data to verify that an abnormal vehicular movement event has occurred, and
a notification routine to automatically initiate a notice of loss claim and trigger communication with a client that a validated abnormal vehicular movement event has occurred and including data relating to the severity and type of the event.

13. The method of claim 12 wherein the abnormal vehicular movement event comprises one of a G-force measurement or an acoustic measurement being above a select threshold, or an air bag deployment or a crash sensor activation.

14. The method of claim 12 wherein the event routine receives a validation score from the validation routine and generates an output comprising vehicle identification information, vehicle location information and the validation routine and transfers the output to the notification routine.

15. The method of claim 14 wherein the notification routine comprises a source rules routine which automatically searches for information on road, weather and traffic conditions at a time and location of the abnormal vehicular movement event.

16. The method of claim 14 wherein the notification routine comprises a source rules routine which automatically searches for first responders and healthcare facilities proximate location of the abnormal vehicular movement event.

17. The method of claim 14 wherein the notification routine comprises a business rules routine which selectively automatically generates a notification message to a carrier and authorities.

18. The method of claim 14 wherein the notification routine automatically verifies coverage based on time and location of the abnormal vehicular movement event and the vehicle identification information.
